(19) United States
(12) Patent Application Publication
(10) Pub. No.: US 2023/0385699 A1
(43) Pub. Date: Nov. 30, 2023

(54) DATA BOUNDARY DERIVING SYSTEM AND METHOD

(71) Applicant: SIMPLATFORM CO., LTD, Seoul (KR)

(72) Inventors: Dae Gun LIM, Daejeon (KR); Min Sang KIM, Seoul (KR); Hong Gyu RYU, Seoul (KR)

(21) Appl. No.: 18/323,866

(22) Filed: May 25, 2023

Related U.S. Application Data
(63) Continuation of application No. PCT/KR2021/016842, filed on Nov. 17, 2021.

(30) Foreign Application Priority Data
Nov. 26, 2020 (KR) 10-2020-0161253

(51) Int. Cl. G06N 20/00

(52) U.S. Cl. CPC G06N 20/00

(57) ABSTRACT

Data boundary deriving system and method include: a sample data reception unit configured to receive a plurality of pieces of sample data having a plurality of characteristic values; a cluster generation unit configured to generate a plurality of clusters by classifying the plurality of pieces of sample data; a probability density function derivation unit configured to derive a probability density function based on the characteristic values of data included in each of the plurality of generated clusters; and a learning data generation unit configured to generate learning data by calculating the values of the probability density function of a cluster including each piece of sample data for each of the plurality of sample data and labeling second sample data based on the calculated values, and an operating method thereof.

### CROSS-REFERENCE TO RELATED APPLICATIONS

This application is a Continuation of International Application No. PCT/KR2021/016842 filed on Nov. 17, 2021, which claims priority from Korean Application No. 10-2020-0161253 filed on Nov. 26, 2020. The aforementioned applications are incorporated herein by reference in their entireties.

### TECHNICAL FIELD

The present invention relates to a data boundary deriving system and method, and more particularly, to a system and method that derive the boundary of normal data by analyzing unlabeled sample data and generate learning data by labeling the data based on the derived boundary.

### RELATED ART

As artificial intelligence technology develops, there is boosted smart factory technology that can monitor various types of information of a process or equipment with sensors and detect or predict abnormal states based on artificial intelligence, thereby increasing the efficiency of the process and minimizing the effort required for management.

Korean Patent No. 10-0570528 entitled “Process Equipment Monitoring System and Model Generation Method,” which is a prior art, proposes a system that can determine abnormal states of process equipment using artificial intelligence. In order to manage a process using artificial intelligence as described above, it is necessary to analyze data obtained from each process and establish an artificial intelligence model through learning.

However, for this purpose, it is necessary to provide learning data by classifying data related to each process or each piece of equipment into data for normal states and data for abnormal states. The process of classifying data according to the state thereof is referred to as labeling. However, in many cases, equipment does not frequently cause errors in the initial stage of operation. Furthermore, in order to deal with situations in which errors occur due to aging, etc., there must be cases where such situations have occurred. Accordingly, it is difficult to obtain data for abnormal states, other than data for normal states, for learning.

Therefore, there is a demand for a method capable of preparing learning data in order to, even without data for an abnormal state, derive the boundary of data for a normal state and classify data having a specific value as data for a normal state or data for an abnormal state based on the boundary.

### SUMMARY

An object of the present invention is to generate learning data that can establish an artificial intelligence model capable of identifying an abnormal state by labeling sample data even when there is no learning data for the abnormal state.

An object of the present invention is to generate labeled learning data based on characteristic values of sample data without a separate labeling operation.

An object of the present invention is to automatically generate labeled learning data and to train an artificial intelligence model capable of detecting an abnormal state based on the labeled learning data.

An object of the present invention is to generate learning data without collecting learning data for an abnormal state so that the abnormal state can be detected, thereby enabling artificial intelligence-based abnormal state detection even when it is difficult to collect learning data, as in the case of initially installed equipment or an initially installed process.

In order to accomplish the above objects, an embodiment of the present invention provides a data boundary deriving system including: a sample data reception unit configured to receive a plurality of pieces of sample data having a plurality of characteristic values; a cluster generation unit configured to generate a plurality of clusters by classifying the plurality of pieces of sample data; a probability density function derivation unit configured to derive a probability density function based on the characteristic values of data included in each of the plurality of generated clusters; and a learning data generation unit configured to generate learning data by calculating the values of the probability density function of a cluster including each piece of sample data for each of the plurality of sample data and labeling second sample data based on the calculated values.

In this case, the probability density function derivation unit may derive the mean value of the characteristic values of sample data included in each of the plurality of clusters and a covariance matrix for all the characteristic values, and may derive the probability density function using the mean value and the covariance matrix.

Furthermore, the probability density function derivation unit may derive the probability density function by the following equation:

f(x)=e^{-(x-μ)′Σ}^{^{−1}}^{(x-μ)/2}
where:
x is the n-dimensional characteristic value matrix of each piece of data;
μ is the n-dimensional matrix of mean values for respective characteristics of the respective pieces of data; and
Σ is the covariance matrix.

Furthermore, the sample data reception unit may identify outliers from the plurality of pieces of received sample data and remove the identified outliers, and the cluster generation unit may generate the clusters using the sample data from which the outliers have been removed.

Furthermore, the learning data generation unit may set an area including the sample data and select data, representing points having regular intervals within the area, as the second sample data, and may generate the learning data by labeling the second sample data.

Furthermore, the learning data generation unit may set a value, corresponding to a predetermined proportion of a peak of probability density function values of the respective pieces of second sample data, as a boundary value, and may label the individual pieces of data based on the boundary value.

The present invention enables the generation of learning data that can establish an artificial intelligence model capable of identifying an abnormal state by labeling sample data even when there is no learning data for the abnormal state.

The present invention has the effect of being able to generate labeled learning data based on characteristic values of sample data without a separate labeling operation.

The present invention has the effect of being able to automatically generate labeled learning data and train an artificial intelligence model capable of detecting an abnormal state based on the labeled learning data.

The present invention has the effect of being able to generate learning data without collecting learning data for an abnormal state so that the abnormal state can be detected, thereby enabling artificial intelligence-based abnormal state detection even when it is difficult to collect learning data, as in the case of initially installed equipment or an initially installed process.

### BRIEF DESCRIPTION OF THE DRAWINGS

FIG. 1 is a block diagram showing the internal configuration of a data boundary deriving system according to an embodiment of the present invention;

FIG. 2 is a diagram illustrating an example of a case of deriving outliers from sample data in a data boundary deriving system according to an embodiment of the present invention;

FIG. 3 is a diagram showing an example of a case where a plurality of clusters are generated in a data boundary deriving system according to an embodiment of the present invention;

FIG. 4 is a diagram showing an example of the results obtained by deriving a data boundary in a data boundary deriving system according to an embodiment of the present invention; and

FIG. 5 is a flowchart illustrating the flow of a data boundary deriving method according to an embodiment of the present invention.

### DETAILED DESCRIPTION

In order to accomplish the above objects, an embodiment of the present invention provides a data boundary deriving system including: a sample data reception unit configured to receive a plurality of pieces of sample data having a plurality of characteristic values; a cluster generation unit configured to generate a plurality of clusters by classifying the plurality of pieces of sample data; a probability density function derivation unit configured to derive a probability density function based on the characteristic values of data included in each of the plurality of generated clusters; and a learning data generation unit configured to generate learning data by calculating the values of the probability density function of a cluster including each piece of sample data for each of the plurality of sample data and labeling second sample data based on the calculated values.

In this case, the probability density function derivation unit may derive the mean value of the characteristic values of sample data included in each of the plurality of clusters and a covariance matrix for all the characteristic values, and may derive the probability density function using the mean value and the covariance matrix.

Furthermore, the probability density function derivation unit may derive the probability density function by the following equation:

f(x)=e^{-(x-μ)′Σ}^{^{−1}}^{(x-μ)/2}
where:
x is the n-dimensional characteristic value matrix of each piece of data;
μ is the n-dimensional matrix of mean values for respective characteristics of the respective pieces of data; and
Σ is the covariance matrix.

Furthermore, the sample data reception unit may identify outliers from the plurality of pieces of received sample data and remove the identified outliers, and the cluster generation unit may generate the clusters using the sample data from which the outliers have been removed.

Furthermore, the learning data generation unit may set an area including the sample data and select data, representing points having regular intervals within the area, as the second sample data, and may generate the learning data by labeling the second sample data.

Furthermore, the learning data generation unit may set a value, corresponding to a predetermined proportion of a peak of probability density function values of the respective pieces of second sample data, as a boundary value, and may label the individual pieces of data based on the boundary value.

Hereinafter, preferred embodiments of the present invention will be described in detail with reference to the accompanying drawings. In the description of the present invention, when it is determined that a detailed description of a related known configuration or function may obscure the gist of the present invention, the detailed description will be omitted. In addition, in the description of embodiments of the present invention, specific numerical values are only examples, and the scope of the invention is not limited thereby.

A data boundary deriving system according to the present invention may be configured in the form of a server that is equipped with a central processing unit (CPU) and memory and is connectable to another terminal over a communication network such as the Internet. However, the present invention is not limited by components such as the central processing unit, the memory, etc. In addition, the data boundary deriving system according to the present invention may be configured as a physical device, or may be implemented in a form distributed over a plurality of devices.

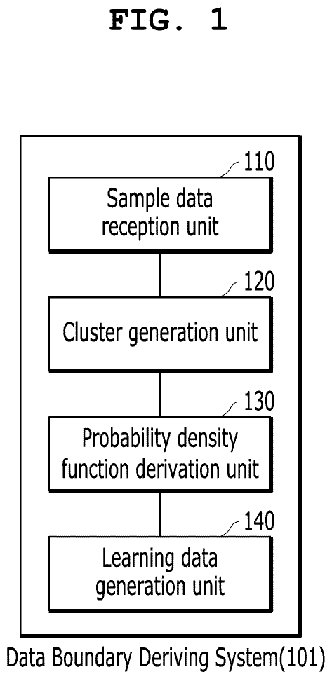

FIG. 1 is a block diagram showing the internal configuration of a data boundary deriving system according to an embodiment of the present invention.

As shown in the drawing, the data boundary deriving system 101 according to an embodiment of the present invention may be configured to include a sample data reception unit 110, a cluster generation unit 120, a probability density function derivation unit 130, and a learning data generation unit 140. The individual components may be software modules that operate in the physically same computer system, and may have forms that operate in such a manner that two or more physically separate computer systems are configured to operate in conjunction with each other. Various embodiments including the same functions fall within the scope of the present invention.

The sample data reception unit 110 receives a plurality of pieces of sample data having a plurality of characteristic values. As described above, the data boundary deriving system 101 according to the embodiment of the present invention is intended to establish and utilize an artificial intelligence model through learning even in a state in which learning data representing various states such as an abnormal state is not obtained. Accordingly, the sample data may be data obtained only in normal states, data obtained by partially processing data obtained in normal states, or data generated by a specific data generation method, rather than data labeled with abnormal states and the like used in general artificial intelligence learning.

The sample data received by the sample data reception unit 110 has a plurality of characteristic values. For example, when the characteristic values are a temperature value and a humidity value, the temperature value and humidity value collected every second may be respective characteristic values, and data obtained by combining the characteristic values into a matrix may constitute one piece of sample data. These characteristic values may be included in various forms when process equipment or the like is monitored. When the number of types of characteristic values is n, an n*1 matrix may constitute one piece of sample data.

The sample data may be data directly collected through sensors in a process and/or equipment. The sample data may be composed of only data derived in normal states, or may be configured to also include information in abnormal states. In some cases, virtual data derived from the results of virtual simulation or the like may be used as the sample data.

Based on the sample data received by the sample data reception unit 110, the boundary of the sample data may be derived through the distribution of the corresponding sample data. When data is labeled based on such a boundary, labeled learning data may be generated. Based on this, an artificial intelligence model capable of detecting abnormal states may be established through learning.

Furthermore, the sample data reception unit 110 may identify outliers from the plurality of pieces of received sample data and remove the identified outliers. Data that has a low correlation with other data and is not useful for analysis due to a sensor error or the like may be removed from the received sample data.

The sample data reception unit 110 may use a local outlier factor (LOF) to remove outlier data in this manner. The local outlier factor is a methodology that can identify data far from dense data as an outlier by also considering the density of adjacent data. To this end, the distances to individual adjacent neighbors are obtained, and a density is calculated using the distances to a predetermined number of adjacent neighbors, and then an outlier may be identified based on this. Data from which one or more outliers have been removed by the sample data reception unit 110 is determined to be valid data and the boundary of the corresponding data is derived, thereby obtaining an effect of labeling each piece of data.

The cluster generation unit 120 generates a plurality of clusters by classifying the plurality of pieces of sample data. In the present invention, the boundary of the sample data is derived using a probability density function (PDF). In this case, in the case where the overall data is classified into multiple clusters, it is difficult to derive an accurate boundary when a probability density function is obtained using a single set of criteria.

Accordingly, when the overall sample data can be grouped into a plurality of clusters, the cluster generation unit 120 may group the sample data into a plurality of clusters and derive the boundary of the overall data through probability density function values for the respective clusters.

In order to generate clusters in the cluster generation unit 120, an algorithm such as K-Means or GMM may be employed. Various methods may be applied to construct clusters of highly related data by analyzing the characteristics of the data.

In order to generate clusters in this manner, the cluster generation unit 120 may generate clusters using sample data from which one or more outliers have been removed. When sample data from which one or more outliers have been removed is used in this manner, learning may be performed using more accurate data for normal states.

The probability density function derivation unit 130 derives a probability density function based on the characteristic value of data included in each of the plurality of generated clusters. A probability density function (PDF) is a function representing the distribution of random variables, and the probability density function represents the probability that a result within a range interval will be derived.

As described above, the characteristic values included in the sample data may be multidimensional data, which may be composed of a matrix. A probability density function for data included in a corresponding cluster may be obtained by analyzing a plurality of pieces of sample data each having a characteristic value matrix.

The probability density function derivation unit 130 may derive the mean value of individual characteristic values of sample data included in each of the plurality of clusters and a covariance matrix for all the characteristic values, and may derive a probability density function using the mean value and the covariance matrix. In addition, more accurate results may be obtained by appropriately reducing the overall covariance to be derived. To this end, the covariance may be reduced using the mean of the minimums of the distances between pieces of data within each cluster and the standard deviation. The probability density function is obtained using the covariance derived in a reduced state in this manner.

The distance information between pieces of data used to reduce the covariance in the probability density function derivation unit 130 may utilize the Mahalanobis distance, other than the Euclidean distance. The Mahalanobis distance represents the distance obtained by correcting the Euclidean distance based on the standard deviation calculated at points within a group, and may be calculated in the form of (the transpose matrix of (variate-mean))*(the inverse matrix of the covariance) X*(a variate-mean matrix), where * denotes matrix multiplication.

By applying this method, the probability density function derivation unit may derive the probability density function by the following equation:

f(x)=e^{-(x-μ)′Σ}^{^{−1}}^{(x-μ)/2}
where:
x is the n-dimensional characteristic value matrix of each piece of data;
μ is the n-dimensional matrix of mean values for respective characteristics of the respective pieces of data; and
Σ is the covariance matrix.

When the probability density function is obtained using the mean value matrix of the characteristic values of the data in the cluster and the data covariance matrix as described above, a probability density function value may be calculated by inputting x corresponding to the n-dimensional characteristic value matrix of each piece of data.

The learning data generation unit 140 calculates the probability density function value of a cluster including each piece of sample data for each of the plurality of pieces of sample data, and labels second sample data based on the calculated value, thereby generating learning data. When sample data is input to the probability density function value of the cluster that includes each piece of sample data, a probability density function value for each piece of sample data is derived. When a reference value is set for this value, individual values may be classified.

Through this, a boundary may be determined based on a reference value, and whether each piece of data is outside or inside the boundary may be determined. Accordingly, the learning data generation unit 140 may perform labeling based on whether each piece of data is inside or outside the boundary, and may use the results of the labeling as learning data.

When the learning data generation unit 140 performs labeling, an area in which sample data is present is set in an n-dimensional space, grid points are formed at regular intervals in the set area, data representing each of the grid points is generated as second sample data, and the labeling of the generated second sample data may be performed together. Since the sample data is data collected in normal states, it may be difficult to perform labeling for abnormal states when only sample data is input. When the second sample data representing the grid points of the area where the sample data is present is all labeled, learning data appropriately labeled with normal and abnormal states may be generated.

Since the probability density function is determined based on the initial sample data, it may be possible to broadly reinforce the learning data by labeling data collected or generated thereafter based on the criteria.

The learning data generation unit 140 may set a value corresponding to the predetermined proportion of the peak of the probability density function values of the respective pieces of data as a boundary value, and may label the individual pieces of data based on the boundary value. The boundary value may be determined to be about 0.6065306597126334 times the peak of the probability density function. This may be a probability value when it is 1 sigma (standard deviation) away from the mean in a normal distribution. In the case where the criteria are set in this manner, when data is mapped to a point in a dimensional space corresponding to the number of characteristic values of each piece of data, whether the point is inside or outside the boundary may be determined, so that the labeling of data is facilitated and learning data can be easily generated. In this case, the sharpness of the boundary may be adjusted by adjusting the distribution of the probability density function through the adjustment of the covariance used to obtain the probability density function.

In this case, when the learning data generation unit 140 applies the probability density function, the probability density function of each of a plurality of clusters may be applied to one point, and presence inside or outside the boundary may be determined based on the sum of the plurality of probability density function values.

When the labeled learning data is prepared as described above, classification learning may be performed using various methods based on this, and a final boundary may be set using an artificial intelligence model derived through the learning. Thereafter, it may be possible to determine whether there is an abnormality for the data collected in real time through the classification of the artificial intelligence model. Compared to the method of performing classification by calculating the probability density function of input data, the method of using an artificial intelligence model trained using generated learning data may perform real-time analysis more rapidly.

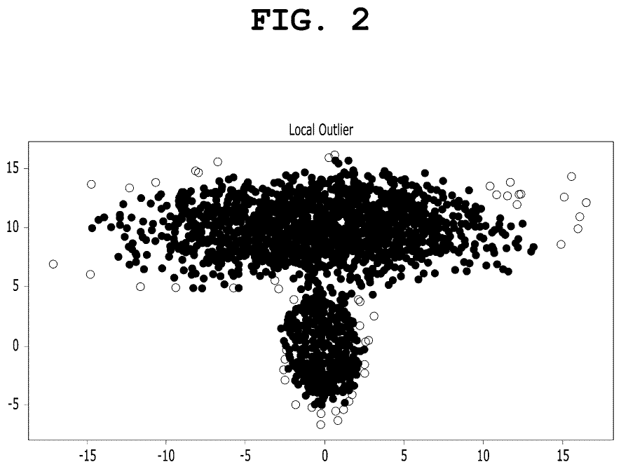

FIG. 2 is a diagram illustrating an example of a case of deriving outliers from sample data in a data boundary deriving system according to an embodiment of the present invention.

As shown in the drawing, when sample data is received, incorrect data may be input as some of the data due to a sensor error or various instantaneous problems. When cluster generation and probability density function generation are performed with such incorrect data included, it is difficult to derive an accurate boundary value.

Therefore, in the present invention, outliers are removed from the received sample data. To remove outliers, a local outlier factor may be employed. As described above, the local outlier factor is a method of identifying outliers based on the density of adjacent points. In the drawing, the red dots are points derived as outliers using the local outlier factor, and the black dots are points determined to be non-outliers.

The accuracy of analysis may be increased by removing outlier data in an early stage and then performing analysis as described above.

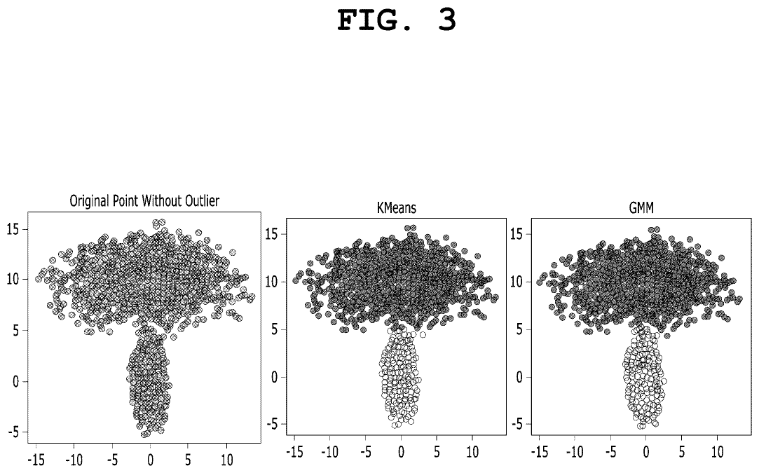

FIG. 3 is a diagram showing an example of a case where a plurality of clusters are generated in a data boundary deriving system according to an embodiment of the present invention.

In the example of FIG. 2, it is necessary to extract a boundary by analyzing the distribution of the points marked in black. As shown in the drawing, even visually, it can be seen that the characteristics of the data are classified into a part having a wide lateral distribution in the upper portion and a part having a wide vertical distribution in the lower portion. When these parts are grouped together and the characteristics thereof are analyzed, it becomes difficult to measure an accurate boundary, and also it becomes difficult to perform accurate analysis.

Therefore, in the present invention, when data can be classified into multiple parts according to the characteristics thereof, it is classified into a plurality of clusters and a probability density function is obtained for each of the clusters, thereby enabling the more accurate identification of a boundary.

In the example of the drawing, when a clustering algorithm such as K-means or GMM is applied, the laterally wide part in the upper portion and the vertically wide part in the lower portion are distinguished from each other, as shown on the right side of the drawing. As shown in the drawing, although the clusters to which some data belongs may be changed according to the clustering algorithm, the overall distribution can be maintained, and thus the present invention is not limited to a specific clustering algorithm.

When data is clustered in this manner, a probability density function may be obtained for each cluster, and a boundary for the overall data may be derived through a boundary generated through the above probability density function.

In the drawing, a case where each piece of data is two-dimensional matrix data in which the piece of data has two characteristic values (e.g., temperature and humidity) is shown as an example. In practice, there are many cases where data is analyzed as data of a large number of dimensions (data having various character values). In these cases, clustering in multiple dimensions may be performed. In order to check the results of the clustering, and/or the like, a dimensionality reduction method such as PCA may be applied to allow the results to be checked in a visualizable number of dimensions.

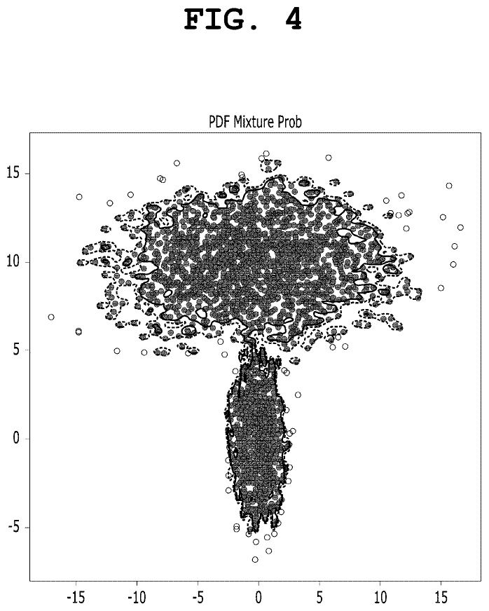

FIG. 4 is a diagram showing an example of the results obtained by deriving a data boundary in a data boundary deriving system according to an embodiment of the present invention.

As shown in the drawing, when probability density function values are obtained for respective pieces of data through the data boundary deriving system of the present invention, a data boundary is derived based on the boundary of the probability density function values. In the drawing, the red dots represent points derived as outliers, and the boundary of the upper cluster is indicated by the purple solid line and the boundary of the lower cluster is indicated by the yellow solid line. Through this, the boundary that groups pieces of data is derived, so that learning data can be generated by labeling various pieces of data through the determination of presence inside or outside the boundary.

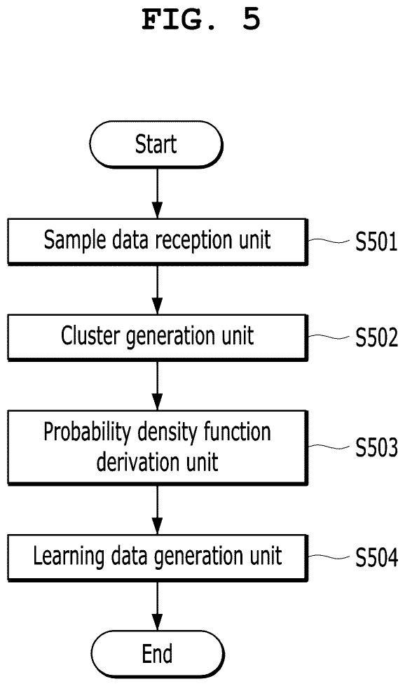

FIG. 5 is a flowchart illustrating the flow of a data boundary deriving method according to an embodiment of the present invention.

The data boundary deriving method according to the present invention is a method of deriving the boundary of data in a data boundary deriving system equipped with a central processing unit and memory, and may be driven in such a computing system.

Accordingly, the data boundary deriving method includes all the characteristic configurations described in conjunction with the data boundary deriving system described above, and the items that will not be described in the following description can also be implemented with reference to the description of the data boundary deriving system described above.

In a sample data reception step S501, there are received a plurality of pieces of sample data having a plurality of characteristic values. As described above, the data boundary deriving method according to the embodiment of the present invention is intended to establish and utilize an artificial intelligence model through learning even in a state in which learning data representing various states such as an abnormal state is not obtained. Accordingly, the sample data may be data obtained only in normal states, data obtained by partially processing data obtained in normal states, or data generated by a specific data generation method, rather than data labeled with abnormal states and the like used in general artificial intelligence learning.

The sample data received in the sample data reception step S501 has a plurality of characteristic values. For example, when the characteristic values are a temperature value and a humidity value, the temperature value and humidity value collected every second may be respective characteristic values, and data obtained by combining the characteristic values into a matrix may constitute one piece of sample data. These characteristic values may be included in various forms when process equipment or the like is monitored. When the number of the types of characteristic values is n, an n*1 matrix may constitute one piece of sample data.

Based on the sample data received in the sample data reception step S501, the boundary of the sample data may be derived through the distribution of the corresponding sample data. When data is labeled based on such a boundary, labeled learning data may be generated. Based on this, an artificial intelligence model capable of detecting abnormal states may be established through learning.

Furthermore, in the sample data reception step S501, outliers may be identified from the plurality of pieces of received sample data, and the identified outliers may be removed. Data that has a low correlation with other data and is not useful for analysis due to a sensor error or the like may be removed from the received sample data.

In a cluster generation step S502, a plurality of clusters are generated by classifying the plurality of pieces of sample data. In the present invention, the boundary of the sample data is derived using a probability density function (PDF). In this case, in the case where the overall data is classified into multiple clusters, it is difficult to derive an accurate boundary when a probability density function is obtained using a single set of criteria.

Accordingly, in the cluster generation step S502, when the overall sample data can be grouped into a plurality of clusters, the sample data may be grouped into a plurality of clusters, and the boundary of the overall data may be derived through probability density function values for the respective clusters.

In order to generate clusters in the cluster generation step S502, an algorithm such as K-Means or GMM may be employed. Various methods may be applied to construct clusters of highly related data by analyzing the characteristics of the data.

In order to generate clusters in this manner, in the cluster generation step S502, clusters may be generated using sample data from which outliers have been removed. When sample data from which one or more outliers have been removed is used in this manner, learning may be performed using more accurate data for normal states.

In a probability density function derivation step S503, a probability density function is derives based on the characteristic value of data included in each of the plurality of generated clusters. A probability density function (PDF) is a function representing the distribution of random variables, and the probability density function represents the probability that a result within a range interval will be derived.

As described above, the characteristic values included in the sample data may be multidimensional data, which may be composed of a matrix. A probability density function for data included in a corresponding cluster may be obtained by analyzing a plurality of pieces of sample data each having a characteristic value matrix.

In the probability density function derivation step S503, the mean value of individual characteristic values of sample data included in each of the plurality of clusters and a covariance matrix for all characteristic values may be derived, and a probability density function may be derived using the mean value and the covariance matrix. In addition, more accurate results may be obtained by appropriately reducing the overall covariance to be derived. To this end, the covariance may be reduced using the mean of the minimums of the distances between pieces of data within each cluster and the standard deviation. The probability density function is obtained using the covariance derived in a reduced state in this manner.

The distance information between pieces of data used to reduce the covariance in the probability density function derivation step S503 may utilize the Mahalanobis distance, other than the Euclidean distance. The Mahalanobis distance represents the distance obtained by correcting the Euclidean distance based on the standard deviation calculated at points within a group, and may be calculated in the form of (the transpose matrix of (variate-mean))*(the inverse matrix of the covariance) X*(a variate-mean matrix), where * denotes matrix multiplication.

By applying this method, the probability density function derivation unit may derive the probability density function by the following equation:

f(x)=e^{-(x-μ)′Σ}^{^{−1}}^{(x-μ)/2}
where:
p is the number of characteristic values included in one piece of data;
x is the n-dimensional characteristic value matrix of each piece of data;
μ is the n-dimensional matrix of mean values for respective characteristics of the respective pieces of data; and
Σ is the covariance matrix.

When the probability density function is obtained using the mean value matrix of the characteristic values of the data in the cluster and the data covariance matrix as described above, a probability density function value may be calculated by inputting x corresponding to the n-dimensional characteristic value matrix of each piece of data.

In a learning data generation step S504, the probability density function value of a cluster including each piece of sample data is calculated for each of the plurality of pieces of sample data, and each piece of sample data is labeled based on the calculated value, thereby generating learning data. When sample data is input to the probability density function value of the cluster that includes each piece of sample data, a probability density function value for each piece of sample data is derived. When a reference value is set for this value, individual values may be classified.

Through this, a boundary may be determined based on a reference value, and whether each piece of data is in the inside or outside of the boundary may be determined. Accordingly, the learning data generation unit 140 may perform labeling based on whether each piece of data is inside or outside the boundary, and may use the results of the labeling as learning data.

In the learning data generation step S504, when labeling is performed, an area in which sample data is present is set in an n-dimensional space, grid points are formed at regular intervals in the set area, data representing each of the grid points is generated as second sample data, and the labeling of the generated second sample data may be performed together. Since the sample data is data collected in normal states, it may be difficult to perform labeling for abnormal states when only sample data is input. When the second sample data representing the grid points of the area where the sample data is present is all labeled, learning data appropriately labeled with normal and abnormal states may be generated.

In the learning data generation step S504, a value corresponding to the predetermined proportion of the peak of the probability density function values of the respective pieces of data may be set as a boundary value, and the individual pieces of data may be labeled based on the boundary value. The boundary value may be determined to be about 0.6065306597126334 times the peak of the probability density function. This may be a probability value when it is 1 sigma (standard deviation) away from the mean in a normal distribution. In the case where the criteria are set in this manner, when data is mapped to a point in a dimensional space corresponding to the number of characteristic values of each piece of data, whether the point is inside or outside the boundary may be determined, so that the labeling of data is facilitated and learning data can be easily generated. In this case, the sharpness of the boundary may be adjusted by adjusting the distribution of the probability density function through the adjustment of the covariance used to obtain the probability density function.

In this case, when the learning data generation unit 140 applies the probability density function, the probability density function of each of a plurality of clusters may be applied to one point, and presence inside or outside the boundary may be determined based on the sum of the plurality of probability density function values.

The data boundary deriving method according to the present invention may be produced as a program that cause a computer to perform the data boundary deriving method, and may be recorded on a computer-readable storage medium.

Examples of the computer-readable storage medium include magnetic media such as hard disks, floppy disks and magnetic tapes, optical storage media such as CDROMs and DVDs, magneto-optical media such as floptical disks, and hardware devices specially configured to store and execute program instructions, such as ROM, RAM, flash memory, and the like.

Examples of the program instructions include high-level language codes executable by a computer using an interpreter or the like as well as machine language codes such as those produced by a compiler. The hardware devices may each be configured to act as one or more software modules in order to perform processing according to the present invention, and vice versa.

Although the foregoing description has been given with reference to the embodiments, those skilled in the art may modify and alter the present invention in various manners without departing from the spirit and scope of the present invention described in the claims below.

The present invention is directed to a data boundary deriving system and method. The present invention provides a data boundary deriving system including: a sample data reception unit configured to receive a plurality of pieces of sample data having a plurality of characteristic values; a cluster generation unit configured to generate a plurality of clusters by classifying the plurality of pieces of sample data; a probability density function derivation unit configured to derive a probability density function based on the characteristic values of data included in each of the plurality of generated clusters; and a learning data generation unit configured to generate learning data by calculating the values of the probability density function of a cluster including each piece of sample data for each of the plurality of sample data and labeling second sample data based on the calculated values, and also provides an operating method thereof.

What is claimed is:

1. A data boundary deriving system comprising:
a sample data reception unit configured to receive a plurality of pieces of sample data having a plurality of characteristic values;
a cluster generation unit configured to generate a plurality of clusters by classifying the plurality of pieces of sample data;
a probability density function derivation unit configured to derive a probability density function based on characteristic values of data included in each of the plurality of generated clusters; and
a learning data generation unit configured to generate learning data by calculating values of the probability density function of a cluster including each piece of sample data for each of the plurality of sample data and labeling second sample data based on the calculated values.

2. The data boundary deriving system of claim 1, wherein the probability density function derivation unit is further configured to:
derive a mean value of characteristic values of sample data included in each of the plurality of clusters and a covariance matrix for all the characteristic values; and
derive the probability density function using the mean value and the covariance matrix.

3. The data boundary deriving system of claim 2, wherein the probability density function derivation unit derives the probability density function by the following equation:
f(x)=e^{-(x-μ)′Σ}^{^{−1}}^{(x-μ)/2}
where:
x is an n-dimensional characteristic value matrix of each piece of data;
μ is an n-dimensional matrix of mean values for respective characteristics of the respective pieces of data; and
Σ is the covariance matrix.

4. The data boundary deriving system of claim 1, wherein the sample data reception unit identifies outliers from the plurality of pieces of received sample data and removes the identified outliers, and
wherein the cluster generation unit generates the clusters using the sample data from which the outliers have been removed.

5. The data boundary deriving system of claim 1, wherein the learning data generation unit is further configured to:
set an area including the sample data, and selects data, representing points having regular intervals within the area, as the second sample data; and
generate the learning data by labeling the second sample data.

6. The data boundary deriving system of claim 1, wherein the learning data generation unit is further configured to:
set a value, corresponding to a predetermined proportion of a peak of probability density function values of the respective pieces of second sample data, as a boundary value; and
label the individual pieces of data based on the boundary value.

7. A data boundary deriving method operating performed in a data boundary deriving system equipped with a central processing unit and memory, the data boundary deriving method comprising:
a sample data reception step of receiving a plurality of pieces of sample data having a plurality of characteristic values;
a cluster generation step of generating a plurality of clusters by classifying the plurality of pieces of sample data;
a probability density function derivation step of deriving a probability density function based on characteristic values of data included in each of the plurality of generated clusters; and
a learning data generation step of generating learning data by calculating values of the probability density function of a cluster including each piece of sample data for each of the plurality of sample data and labeling the individual pieces of sample data based on the calculated values.

8. The data boundary deriving method of claim 7, wherein the probability density function derivation step comprises:
deriving a mean value of characteristic values of sample data included in each of the plurality of clusters and a covariance matrix for all the characteristic values; and
deriving the probability density function using the mean value and the covariance matrix.

9. The data boundary deriving method of claim 8, wherein the probability density function derivation step comprises deriving the probability density function by the following equation:
f(x)=e^{-(x-μ)′Σ}^{^{−1}}^{(x-μ)/2}
where:
x is an n-dimensional characteristic value matrix of each piece of data;
μ is an n-dimensional matrix of mean values for respective characteristics of the respective pieces of data; and
Σ is the covariance matrix.

10. The data boundary deriving method of claim 7, wherein the sample data reception step comprises identifying outliers from the plurality of pieces of received sample data and removing the identified outliers, and
wherein the cluster generation step comprises generating the clusters using the sample data from which the outliers have been removed.

11. The data boundary deriving method of claim 7, wherein the learning data generation step comprises:
setting an area including the sample data, and selecting data, representing points having regular intervals within the area, as the second sample data; and
generating the learning data by labeling the second sample data.

12. The data boundary deriving method of claim 7, wherein the learning data generation step comprises:
setting a value, corresponding to a predetermined proportion of a peak of probability density function values of the respective pieces of second sample data, as a boundary value; and
labeling the individual pieces of data based on the boundary value.

13. A computer-readable storage medium having stored thereon a program that causes a computer to perform the method of claim 7.
